(19) United States
(12) Patent Application Publication
(10) Pub. No.: US 2025/0086770 A1
(43) Pub. Date: Mar. 13, 2025

(54) METHOD FOR ENSURING AN INTEGRITY OF IMAGE DATA OF A VEHICLE

(71) Applicant: Robert Bosch GmbH, Stuttgart (DE)

(72) Inventors: Oliver Kamphenkel, Lehrte (DE); Rene Fritzsche, Harsum (DE)

(21) Appl. No.: 18/771,075

(22) Filed: Jul. 12, 2024

(30) Foreign Application Priority Data
Sep. 12, 2023 (DE) 10 2023 208 863.0

(51) Int. Cl. G06T 7/00; G06V 10/98

(52) U.S. Cl. CPC G06T 7/0002; G06V 10/993; G06T 2207/30168

(57) ABSTRACT

A method for ensuring the integrity of image data of a vehicle. The method includes: providing the image data, wherein the image data results from a recording of at least one camera of the vehicle; generating a metric for the image data in order to, based on said metric, provide a check of the image data with respect to integrity; carrying out at least one camera-based vehicle function of the vehicle using the image data; checking, with respect to integrity, the image data used for the at least one camera-based vehicle function using the generated metric; performing at least one action based on a result of the check, so as to ensure the integrity of the image data. A computer program, a device, and a storage medium are also described.

### CROSS REFERENCE

The present application claims the benefit under 35 U.S.C. § 119 of German Patent Application No. DE 10 2023 208 863.0 filed on Sep. 12, 2023, which is expressly incorporated herein by reference in its entirety.

### FIELD

The present invention relates to a method for ensuring an integrity of image data of a vehicle. The present invention also relates to a computer program, a device and a storage medium for this purpose.

### BACKGROUND INFORMATION

Modern vehicles can have a wide range of camera-based vehicle functions, such as a rear-view backup camera, lane departure warning system, brake assist or driver/passenger compartment monitoring and (semi-)automated driving functions. Many of these functions can place safety-relevant integrity requirements (Functional Safety, Automotive Safety Integrity Level—ASIL) on the content of image data from the vehicle's cameras. In the past, the majority of functions were preferably implemented on dedicated control units (ECUs), but there are now plans to implement as many vehicle functions as possible on a central control unit, which processes all image data centrally. The aforementioned camera-based vehicle functions can change image data. Centralized processing of all image data can lead to increased changes. To counteract this, copies of the image data can be created. One disadvantage, however, is that this can lead to inefficient processing due to the additional data generated.

### SUMMARY

The present invention includes a method, a computer program, a device, and a computer-readable storage medium. Features and details of the present invention will emerge from the disclosure herein. Features and details which are described in connection with the method according to the present invention will of course also apply in connection with the computer program according to the present invention, the device according to the present invention and the computer-readable storage medium according to the present invention and vice versa, so that mutual reference is or can always be made with respect to the disclosure of the individual aspects of the present invention.

In particular, the present invention relates to a method for ensuring the integrity of image data of a vehicle. According to an example embodiment of the present invention, the method includes the following steps, wherein the steps can be repeated and/or carried out sequentially:
providing the image data, wherein the image data result from a recording of at least one camera of the vehicle,
generating a metric for the image data in order to, based on said metric, provide a check of the image data with respect to integrity,
executing at least one camera-based vehicle function of the vehicle using the image data,
checking, with respect to integrity, the image data used for the at least one camera-based vehicle function using the generated metric,
performing at least one action based on a result of the check, so as to ensure the integrity of the image data.

The integrity of the image data represents, in particular, that all essential features of the image data for the various vehicle functions are still present. Thus, ensuring integrity can advantageously prevent said essential features of the image data from being removed or distorted by camera-based vehicle functions. Removing or distorting the essential features in the image data could have negative consequences, since, for example, in the context of a camera-based vehicle function, an object or a pedestrian could no longer be identified in the image data and, as a result, a corresponding braking maneuver might not be carried out. The image data can be a single image captured by the at least one camera. Accordingly, the process can relate to a so-called “zero-copy image processing chain,” which does not require image data or images to be copied. The metric can be generated, for example, on the basis of a hashing process or a detection of features of the image (image feature detection). The camera-based vehicle function can be, for example, the provision of a rear-view backup camera, a lane departure warning system, a brake assist, driver/passenger compartment monitoring or a (semi-)automated driving function. The checking can be carried out, for example, by analyzing whether the essential features extracted during the generation of the metric are still present, or by comparing a hash value of the image data with the hash value obtained during the generation of the metric. Furthermore, an effect of the lack of integrity can be examined as part of the check in order to determine an integrity level (Automotive Safety Integrity Level). This can involve assessing how probable a critical situation is to arise due to the lack of integrity of the image data, the severity of the critical situation and possible measures to avoid or eliminate the critical situation. The situation is particularly critical, i.e. potentially dangerous, for at least one person, such as the driver of the vehicle or other road users or pedestrians. The at least one action is carried out, in particular, if the result of the check indicates that the integrity is compromised, for example if essential features are missing or said hash value does not match.

An example embodiment of the present invention may provide that the checking further comprises the following step:
checking whether the camera-based vehicle function reports an image processing error.

The at least one action is also performed based on a result of the check with respect to the image processing error of the camera-based vehicle function. It is possible that at least two camera-based vehicle functions are carried out, and a check is performed to determine whether the at least one other camera-based vehicle function reports an image processing error. In this way, it can be advantageously determined that the previous camera-based vehicle function has changed the image data such that this leads to the image processing error in the next further camera-based vehicle function. Thereafter, at least one action is taken if the result of the check with respect to the image processing error shows that there is an image processing error.

Preferably, an example embodiment of the present invention may provide that the method further comprises the following step:
adding characterizing data to the image data to further perform the check based on the added characterizing data.

The characterizing data can, for example, be a watermark or a comparable identification. The characterizing data can be advantageous to make a destructive change of the image recognizable by a camera-based vehicle function.

Preferably, according to an example embodiment of the present invention, it can be provided that the generation of the metric may comprise the following step:
identifying essential parts of the image data based on feature extraction to perform the check with respect to integrity based on the identified essential parts of the image data.

It is possible that a machine learning model is used to identify the essential parts of the image data based on the feature extraction. The check with respect to integrity can therefore be carried out, for example, by analyzing whether the essential features identified on the basis of the feature extraction are still present after the camera-based vehicle function has been carried out.

According to an advantageous further development of the present invention, it may be provided that the at least one action is selected from:
deactivating at least one other camera-based vehicle function for a current image of the image data,
deactivating the camera-based vehicle function for at least one subsequent image of the image data,
initiating an output of an error message, wherein the error message comprises at least the result of the check.

Deactivating the additional camera-based vehicle function for the current image of the image data can be advantageous in order to avoid using a distorted image, in which essential parts or features may be missing, for another vehicle function. Deactivating the camera-based vehicle function for the at least one following image of the image data may be advantageous to avoid further images being distorted by the camera-based vehicle function or to avoid removing essential parts or features. It can be provided that camera-based vehicle functions essential for vehicle safety remain operational and are therefore not deactivated. Instead of deactivating, the camera-based vehicle function can alternatively be downgraded, which means, for example, that the vehicle can only be driven at a certain speed. The error message may further comprise that the further camera-based vehicle function is not available or is deactivated due to the lack of integrity of the image data, or that the camera-based vehicle function is downgraded. The output can be displayed, for example, on a screen of a driver-assistance system in the vehicle.

It is also possible, within the scope of the present invention, that at least two camera-based vehicle functions are carried out and the at least one action comprises the following step:
Changing a sequence of executing the at least two camera-based vehicle functions.

By changing the sequence, for example, it is advantageous to ensure that the image data are only changed at the end or during a last or later camera-based vehicle function. It is possible that a sequence is provided in which there is a declining integrity level of the image data along the sequence. In other words, the image data in this case are increasingly modified along the sequence by the respective camera-based vehicle functions.

A further advantage can be achieved, within the scope of the present invention, if the image data comprise a previous image and a subsequent image, wherein the subsequent image corresponds to the previous image after the at least one camera- based vehicle function of the vehicle has been carried out using the previous image. In this case, according to an example embodiment of the present invention, the method may further comprise the following step:
checking the subsequent image using the generated metric with respect to integrity in order to additionally check the integrity of the previous image by checking the subsequent image.

As a result, the integrity of the previous image can be checked using the subsequent image, making it unnecessary to check the previous image.

It is possible for the method according to the present invention to be used in a vehicle. The vehicle can, for example, be designed as a motor vehicle and/or a passenger vehicle and/or an autonomous vehicle. The vehicle can have a vehicle device, e.g., for providing an autonomous driving function and/or a driver-assistance system. The vehicle device can be designed to at least partially automatically control and/or accelerate and/or brake and/or steer the vehicle.

The present invention also relates to a computer program, in particular a computer program product, comprising instructions that, when the computer program is executed by a computer, prompt said computer program to carry out the method according to the present invention. The computer program according to the present invention thus brings with it the same advantages as have been described in detail with reference to a method according to the present invention.

The present invention also relates to a device for data processing which is configured to carry out the method according to the present invention. The device can be a computer, for example, that executes the computer program according to the present invention. The computer can comprise at least one processor for executing the computer program. A non-volatile data memory can also be provided, in which the computer program can be stored and from which the computer program can be read by the processor for execution.

The present invention can also relate to a computer-readable storage medium, which comprises the computer program according to the present invention and/or instructions that, when carried out by a computer, prompt said computer program to carry out the method according to the present invention. The storage medium is configured as a data memory such as a hard drive and/or a non-volatile memory and/or a memory card, for example. The storage medium can, for example, be integrated into the computer.

The method according to the present invention can moreover also be designed as a computer-implemented method.

Further advantages, features and details of the present invention will emerge from the following description, in which embodiment examples of the present invention are described in detail with reference to the figures. The features disclosed herein can each be essential to the present invention individually or in any combination.

### BRIEF DESCRIPTION OF THE DRAWINGS

FIG. 1 shows a schematic visualization of a method, a device, a storage medium and a computer program according to embodiment examples of the present invention.

FIG. 2 shows a schematic illustration of a vehicle with a camera according to embodiment examples of the present invention.

FIG. 3 shows a schematic illustration of a method according to embodiment examples of the present invention.

### DETAILED DESCRIPTION OF EXAMPLE EMBODIMENTS

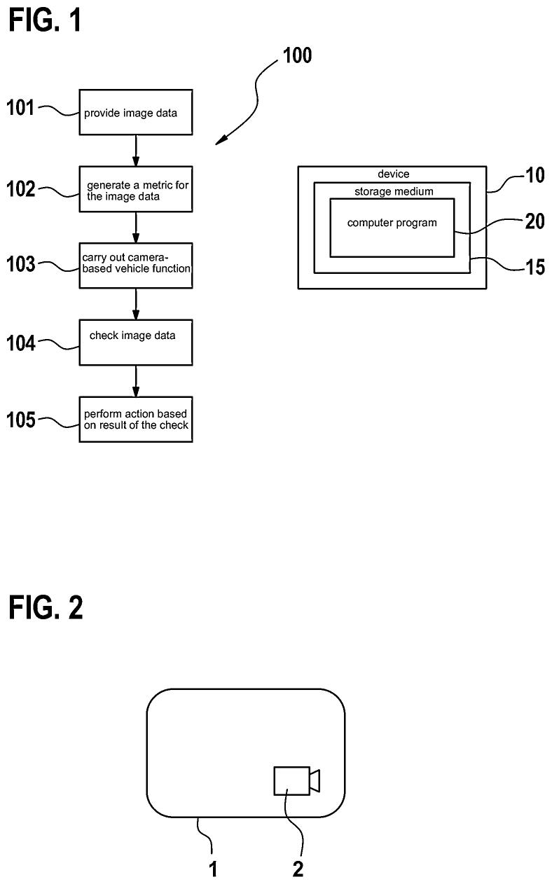

FIG. 1 schematically illustrates a method 100, a device 10, a storage medium 15 and a computer program 20 according to embodiment examples of the present invention.

In particular, FIG. 1 shows a method 100 for ensuring the integrity of image data of a vehicle 1 according to embodiment examples of the present invention. In a first step 101, the image data are provided, wherein the image data result from a recording of at least one camera 2 of the vehicle 1. In a second step 102, a metric for the image data is generated to provide an check, with respect to integrity of the image data based on the metric. In a third step 103, at least one camera-based vehicle function of the vehicle 1 is carried out using the image data. In a fourth step 104, the image data used for the at least one camera-based vehicle function are checked with respect to integrity using the generated metric. In a fifth step 105, the at least one action is performed based on a result of the check 104, so as to ensure the integrity of the image data.

FIG. 2 schematically illustrates a vehicle 1 comprising a camera 2, according to embodiment examples of the present invention.

In particular, the present invention makes it possible to efficiently implement an image processing chain of various camera-based vehicle functions, providing the possibility of monitoring the integrity of the image data for the individual vehicle functions.

An aspect of the present invention describes, in particular, that when a new image of the image data of the vehicle 1 is received, a so-called “image integrity monitor” scans this image and forms its own data structures, which make possible a monitoring of the image content. These can be hashing methods or image feature detection, for example. Moreover, the “image integrity monitor” can introduce additional “non-destructive” data into the image, such as watermarks, which can make a destructive change to the image recognizable by a function.

If the “image integrity monitor” no longer considers the integrity of the image to be guaranteed for another camera-based vehicle function, the following reaction options may be available, for example. At least one of the following camera-based vehicle functions can be deactivated or downgraded for the current image. The camera-based vehicle function that corrupts the image can be deactivated for the following images in order to preserve the other camera-based vehicle functions. The sequence of the camera-based vehicle functions can be rearranged by sorting the camera-based vehicle function that corrupts the image to the end of the chain.

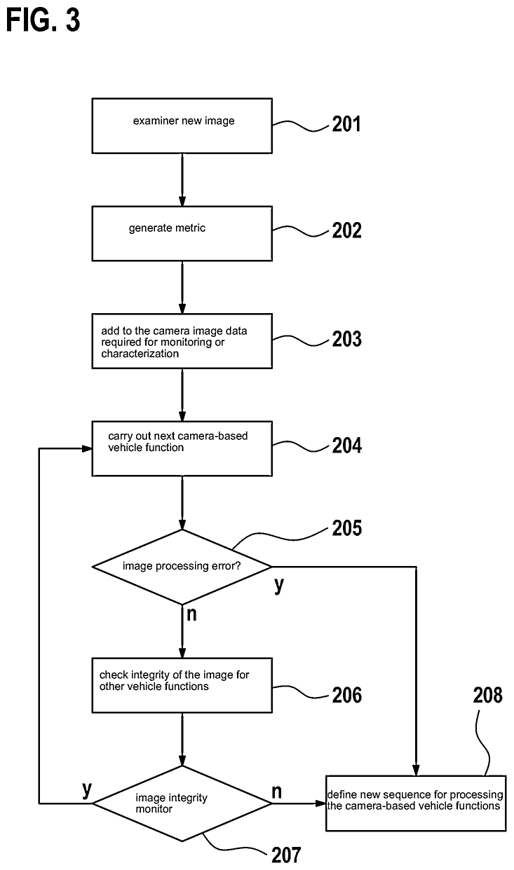

A possible detailed sequence of the “image integrity monitor,” or the method according to the present invention, is illustrated in the flowchart in FIG. 3. In the first steps, a new image of the image processing chain is preferably examined 201, a metric, such as image hash or image feature detection, is generated 202 and data required for monitoring or characterization are added 203 to the camera image.

In the next step 204, the next camera-based vehicle function, for example a rear-view backup camera, driver monitoring, automated driving function or automatic braking function, is preferably carried out. Thereafter, it can be checked whether the vehicle function carried out reports 205 an image processing error. If this is not the case, the monitoring data structures can be used to check 206 the integrity of the image for the other vehicle functions.

This integrity check can be implemented as follows. Using an image feature extraction algorithm, significant and relevant parts of the image can be identified first. This can be implemented using a classic image processing method or a classifying neural network, for example. These recognized features, e.g., a traffic light in the image, a face or a certain feature such as a “watermark,” were preferably also stored during the second step 202 and can now be used for comparison with the current image. One advantage of such a “feature-extraction” implementation is, for example, a rotation-invariant and scaling-invariant output. Thus, image processing functions in this setup can certainly change the size, cut-out, colors or even the rotation of an image, but the integrity check will nevertheless remain successful, as essential parts are retained.

If an image processing error is detected by the vehicle function carried out or by the “image integrity monitor” 207, a new sequence for processing the camera-based vehicle functions can be defined that takes into account 208 the occurrence of the error.

In a particularly advantageous embodiment, the integrity level of the individual functions (QM, ASIL A, ASIL B, . . .) is considered when determining the sequence, preventing low-integrity functions from influencing the data of functions with higher integrity.

In another particularly advantageous embodiment, the subsequent image of the image processing chain can also be used to check the integrity of the previous image after the processing chain, since the subsequent image is preferably not very different from the previous image.

The above explanation of the embodiments describes the present invention solely within the scope of examples. Of course, individual features of the embodiments can be freely combined with one another, if technically feasible, without leaving the scope of the present invention.

What is claimed is:

1. A method for ensuring an integrity of image data of a vehicle, comprising the following steps:
providing the image data, wherein the image data result from a recording of at least one camera of the vehicle;
generating a metric for the image data in order to, based on said metric, provide a check of the image data with respect to integrity;
carrying out at least one camera-based vehicle function of the vehicle using the image data;
checking, with respect to integrity, the image data used for the at least one camera-based vehicle function using the generated metric; and
performing at least one action based on a result of the checking, so as to ensure the integrity of the image data.

2. The method according to claim 1, wherein the checking includes the following step:
checking whether the camera-based vehicle function reports an image processing error;
wherein the at least one action is also performed based on a result of the checking with respect to the image processing error of the camera-based vehicle function.

3. The method according to claim 1, further comprising the following step:
adding characterizing data to the image data to further perform the checking based on the added characterizing data.

4. The method according to claim 1, wherein the generating of the metric includes the following step:
identifying essential parts of the image data based on feature extraction to perform the checking with respect to integrity based on the identified essential parts of the image data.

5. The method according to claim 1, wherein the at least one action is selected from:
deactivating at least one other camera-based vehicle function for a current image of the image data, —deactivating the camera-based vehicle function for at least one subsequent image of the image data,
initiating an output of an error message, wherein the error message includes at least the result of the checking.

6. The method according to claim 1, wherein at least two camera-based vehicle functions are carried out and the at least one action includes the following step:
changing an order of executing the at least two camera-based vehicle functions.

7. The method according to claim 1, wherein the image data comprise a previous image and a subsequent image, wherein the subsequent image corresponds to the previous image after the at least one camera-based vehicle function of the vehicle has been carried out using the previous image, and the method further comprises the following step:
checking the subsequent image using the generated metric with respect to integrity in order to additionally check the integrity of the previous image by checking the subsequent image.

8. A device for data processing, the device configured for ensuring an integrity of image data of a vehicle, the device being configured to:
provide the image data, wherein the image data result from a recording of at least one camera of the vehicle;
generate a metric for the image data in order to, based on said metric, provide a check of the image data with respect to integrity;
carry out at least one camera-based vehicle function of the vehicle using the image data;
check, with respect to integrity, the image data used for the at least one camera-based vehicle function using the generated metric; and
perform at least one action based on a result of the check, so as to ensure the integrity of the image data.

9. A non-transitory computer-readable storage medium on which are stored instructions for ensuring an integrity of image data of a vehicle, the instructions, when executed by a computer, causing the computer to perform the following steps:
providing the image data, wherein the image data result from a recording of at least one camera of the vehicle;
generating a metric for the image data in order to, based on said metric, provide a check of the image data with respect to integrity;
carrying out at least one camera-based vehicle function of the vehicle using the image data;
checking, with respect to integrity, the image data used for the at least one camera-based vehicle function using the generated metric; and
performing at least one action based on a result of the checking, so as to ensure the integrity of the image data.
